(19) United States
(12) Patent Application Publication
(10) Pub. No.: US 2010/0154518 A1
(43) Pub. Date: Jun. 24, 2010

(54) AUTOMATED PACKAGING-FILM TESTING SYSTEMS WITH EFFICIENT LOADING CONFIGURATIONS AND OPERATION AND/OR SERVICE ACCESSIBLE COMPONENTS AND RELATED METHODS AND COMPUTER PROGRAM PRODUCTS

(76) Inventors: Gary Stewart, Raleigh, NC (US); William Arthur Schlieper, II, Cary, NC (US)

Correspondence Address: MYERS BIGEL SIBLEY & SAJOVEC, PO BOX 37428, RALEIGH, NC, 27627, US

(21) Appl. No.: 12/279,919

(22) PCT Filed: Feb. 20, 2007
(86) PCT No.: PCT/US07/04411

§ 371 Date: Feb. 20, 2009

Related U.S. Application Data
(60) Provisional application No. 60/778,293, filed on Mar. 2, 2006.
(60) Provisional application No. 60/803,769, filed on Jun. 2, 2006.

(51) Int. Cl. G01M 3/00

(52) U.S. Cl. 73/52

(57) ABSTRACT

An automated packaging-film testing systems are configured to perform at least one of a Hot Tack Test, Heat Seal Test, and an Aged Seal Test. The systems include at least one of the following components: (a) side-insertion peel clamps that are configured to releasably grip film specimens using a resilient fluid-expandable member that cooperates with a side insertion finger to releasably clamp a film specimen; (b) at least one film specimen positioning clip configured to releasably hold film specimens in position prior to initiation of a test sequence, (c) a motion assembly comprising a single drive system attached to one end portion of an arm that supports and moves all lower seal jaws at each testing station substantially in concert to thereby allow for faster extraction of film specimens from the seal jaws; (d) seal jaw pressure control using a closed-loop pressure system comprising a pressure regulator valve in fluid communication with a pressurized air source without load cells; (e) at least one seal jaw clip configured to releasably slidably mount a seal jaw to a heater block, (f) an upper heater block release mechanism configured to releasably mount a heater block assembly to a reaction frame allow fast operator replacement of heaters and temperature transducers without tools, and (g) an integrated film guide and film cooling system.

### RELATED APPLICATIONS

This application claims the benefit of priority of U.S. Provisional Application Ser. No. 60/778,293, filed Mar. 2, 2006, and U.S. Provisional Application Ser. No. 60/803,769, filed Jun. 2, 2006, the contents of which are hereby incorporated by reference as if recited in full herein.

### FIELD OF THE INVENTION

The present invention relates to test equipment used to evaluate properties of flexible packaging materials, and may particularly suitable to evaluate heat-sealable films.

### BACKGROUND

Food and other products are increasingly manufactured, distributed and utilized in flexible packages that employ a variety of plastic films. The flexible packaging is typically in the form of a pouch or bag, in which one or more sides are sealed together, typically heat-sealed together, to contain the product within. To facilitate proper sealing, the packaging film should have acceptable properties to allow for one or more of: (a) high-speed production; (b) inhibition of product loss during distribution; and/or (c) ease of opening by the end-user. Proper sealing characteristics arise from an appropriate combination of seal pressure, seal temperature and seal duration during the manufacturing process. To find a suitable (or even optimal) combination, three types of laboratory tests can be performed: a Hot Tack Test, a Heat Seal Test, and an Aged Seal Test. In these tests, several specimens (e.g., at least three specimens of each film batch or type) are typically evaluated at a given test condition to facilitate reliable and/or statistically accurate testing data.

Known commercially available systems that perform some or all of the basic Hot Tack, Heat Seal and Aged Seal tests include: (a) the Hottack 3000, manufactured by J&B Material Tester, Belgium; (b) the HTH2 Hot Tack Heat Sealer, manufactured by Dynisco Instruments, Franklin, Mass.; (c) the SL10 Hot Tack Tester, manufactured by Lako Tool, Perrysburg, Ohio, and (d) the Magma Heat Seal & Hot Tack Tester; manufactured by Enepay Corporation, Raleigh, N.C. U.S. Pat. Nos. 5,331,858 and 5,847,284 to H. Theller also describe packaging film testing devices; the contents of these patents are hereby incorporated by reference as if recited in full herein.

### SUMMARY OF EMBODIMENTS OF THE INVENTION

Embodiments of the present invention provide improved automated testing systems that can automatically perform one or more of the Hot Tack, Heat Seal and/or Aged Seal tests on a plurality of different specimens and electronically obtain testing evaluation data for each of the specimens. The testing of the different specimens can be run serially or substantially simultaneously, although typically the latter is conducted.

In some embodiments, the testing systems can perform automated Hot Tack, Heat Seal and Aged Seal tests on at least three film specimens substantially simultaneously.

Some embodiments are directed to automated packaging-film testing systems that are configured to perform at least one of a Hot Tack Test, Heat Seal Test, and an Aged Seal Test. The systems include at least one of the following components: (a) side-insertion peel clamps that are configured to releasably grip film specimens using a resilient fluid-expandable member that cooperates with a side insertion finger to releasably clamp a film specimen; (b) at least one film specimen positioning clip configured to releasably hold film specimens in position prior to initiation of a test sequence, (c) a motion assembly comprising a single drive system attached to one end portion of an arm that supports and moves all lower seal jaws at each testing station substantially in concert to thereby allow for faster extraction of film specimens from the seal jaws; (d) seal jaw pressure control using a closed-loop pressure system comprising a pressure regulator valve in fluid communication with a pressurized air source without load cells; (e) at least one seal jaw clip configured to releasably slidably mount a seal jaw to a heater block, (f) an upper heater block release mechanism configured to releasably mount a heater block assembly to a reaction frame allow fast operator replacement of heaters and temperature transducers without tools, and (g) an integrated film guide and film cooling system.

Some embodiments are directed to automated packaging-film testing systems that include an integrated film guide and film cooling system comprising at least one substantially laterally extending bar with apertures in fluid communication with a fluid source, the at least one bar configured to hold a portion of a film specimen at a forward location while another proximate portion is pulled rearward into a testing position and to direct fluid through the apertures to cool heated film.

Some embodiments are directed to automated testing systems that include: (a) a motion assembly comprising a single drive system attached to one end portion of a laterally extending arm; and (b) a plurality of side-by-side testing stations, each station comprising a lower seal jaw attached to the arm, the lower seal jaw configured to heat and press a respective film specimen, wherein, in operation, the arm moves the plurality of lower seal jaws substantially in concert to thereby allow for fast extraction of film specimens from the seal jaws.

The drive system can be configured to move the arm at a maximum speed of at least about 600 mm/sec.

Some embodiments are directed to automated packaging-film testing systems configured to perform at least one of a Hot Tack Test, Heat Seal Test, and an Aged Seal Test. The systems include: (a) a plurality of testing stations, each station configured to test a respective film specimen; and (b) a plurality of side-insertion peel clamps, one for each respective station, the side-insertion peel clamp comprising a resilient fluid-expandable member that cooperates with a substantially rigid side insertion finger to releasably clamp a film specimen. In some embodiments, each of the side insertion clamp modules are replaceable self-contained units that releasably matably attach to the system and are configured to allow access for replacement and/or service from the front of the system.

The peel clamp modules can be releasably attachable to the system using a single attachment member, such as a bolt accessible from a front of the system.

Some embodiments are directed to automated packaging-film testing systems configured to perform at least one of a Hot Tack Test, Heat Seal Test, and an Aged Seal Test. The systems include at least one film specimen positioning clip mounted on the front of the system. The clip is configured to allow an operator to slide a film specimen in from an open end thereof to releasably hold film specimens in position.

Some embodiments are directed to automated packaging-film testing systems configured to perform at least one of a Hot Tack Test, Heat Seal Test, and an Aged Seal Test. The systems include: (a) a plurality of testing stations, each station configured to test a respective film specimen; and (b) a plurality of side-insertion peel clamp modules, one for each respective station, the side-insertion peel clamp comprising a resilient fluid-expandable member that cooperates with a substantially rigid side insertion finger to releasably clamp a film specimen, wherein each of the side insertion clamp modules are replaceable self-contained units that releasably matably attach to the system and are configured to allow access for replacement and/or service from the front of the system.

The peel clamp modules can be releasably attachable to the system using a single attachment member.

Still other embodiments are directed to automated packaging-film testing systems configured to perform at least one of a Hot Tack Test, Heat Seal Test, and an Aged Seal Test. The system comprises at least one film specimen positioning clip mounted on a front of the system, the clip being configured to allow an operator to slide a film specimen in from an open end thereof to releasably hold film specimens in position.

Yet other embodiments are directed to automated packaging-film testing systems configured to perform at least one of a Hot Tack Test, Heat Seal Test, and an Aged Seal Test. The systems include: (a) at least one testing station comprising seal jaws configured to apply a controlled sealant pressure during specimen testing; and (b) a seal jaw pressure control system in communication with the seal jaws, the pressure control system comprising a closed-loop pressure system with a pressure regulator valve in fluid communication with a pressurized air source and an air seal cylinder with a piston in communication with a respective seal jaw at each testing station. The control system is configured to reliably control sealant pressure exerted by the respective seal jaws using pressure without load cells.

The sealant pressure P-jaw can be calculated using a mathematical relationship between a known regulated pressure P-reg, piston area A-cyl, and seal jaw surface area A-jaw.

Some embodiments are directed to automated packaging-film testing systems configured to perform at least one of a Hot Tack Test, Heat Seal Test, and an Aged Seal Test. The systems include: (a) a mounting frame; (b) a plurality of side-by-side testing stations attached to the mounting frame, each station configured to hold a respective specimen; and (c) a plurality of upper heater block assemblies configured to apply pressure and heat to specimens at each station, the heater block assemblies comprising a temperature transducer, a heater block, and a heater block release mechanism at an upper portion thereof attached to the mounting frame. The release mechanism is configured to allow an operator to rotate the heater block assembly to hand-release the respective heater block, thereby providing fast operator replacement of heaters and temperature transducers without requiring tools.

Some embodiments are directed to automated packaging-film testing systems configured to perform at least one of a Hot Tack Test, Heat Seal Test, and an Aged Seal Test. The systems include: (a) a heater block assembly with a body, the heater block assembly configured to apply heat and pressure to a film specimen during specimen testing; (b) a replaceable seal jaw configured to reside on an upper or lower mounting surface of the heater block; and (c) at least one clip configured to releasably and snugly hold the seal jaw on the heater block.

Other embodiments are directed to automated methods of testing film specimens. The methods include: (a) slidably receiving a film specimen; (b) automatically gripping the film specimen in first and second spaced apart peel clamps; (c) automatically performing a peel test by moving a motion arm down at a specified test rate; (d) electronically collecting force data with the peel force transducers; (e) displaying test data upon completion of the peeling test; and (f) releasing the specimens.

Still other embodiments are directed to computer program products for performing automated film specimen tests. The computer program products include a computer readable storage medium having computer readable program code embodied in the medium. The computer-readable program code includes: (a) computer readable program code configured to direct actuators to cause a peel clamp to grip a film specimen; and (b) computer readable program code configured to carry out at least one of a Hot Tack Test, Heat Seal Test, and Aged Seal Test.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1A is a digital photograph of a front view of an automated system with a plurality of testing stations according to embodiments of the present invention.

FIG. 1B is a schematic illustration of a high-speed motion arm assembly shown in FIG. 1A according to some embodiments of the present invention.

FIG. 2 is a digital photograph of a front perspective view of an internal portion of the automated system shown in FIG. 1A illustrating a mechanical subsystem with a high-speed motion assembly.

FIG. 3A is a digital photograph of an enlarged front perspective view of an internal portion of the system shown in FIG. 1A illustrating exemplary upper and lower modular side-insertion peel clamps according to some embodiments of the present invention.

FIGS. 3B and 3C are schematic illustrations of an outwardly expandable fluid clamping configuration that cooperates with clamping fingers to hold a film specimen according to embodiments of the present invention. FIG. 3B illustrates a non-expanded or “rest” configuration and FIG. 3C illustrates an expanded configuration.

FIG. 4 is a digital photograph of a front view of the modular side-insertion peel clamps shown in FIG. 3A, showing the lower clamp separated from a mating part according to some embodiments of the present invention.

FIG. 5 is a digital photograph of an enlarged front perspective view of the film specimen positioning clip and finger recess shown in FIGS. 3 and 4, with no film specimen inserted.

FIG. 6 is a digital photograph of a side perspective view of the film specimen positioning clip and finger recess shown in FIG. 5, showing an exemplary film specimen being inserted according to embodiments of the present invention.

FIG. 7 is a schematic illustration of a closed-loop pressure control system having a regulator valve and air cylinders according to embodiments of the present invention.

FIG. 8 is a digital photograph of a front perspective view of a closed-loop pressure regulator valve in position in an automated system such as that shown in FIG. 1A according to embodiments of the present invention.

FIG. 9 is a digital photograph of a side perspective view of a seal jaw clip, removed from an automated testing system such as that shown in FIG. 1A, illustrating a seal jaw in place held by the seal jaw clip according to embodiments of the present invention.

FIG. 10 is a digital photograph of a side perspective view of the seal jaw clip shown in FIG. 9 illustrating the associated jaw being removed according to embodiments of the present invention.

FIG. 11 is a digital photograph of a side perspective view of an exemplary underside configuration of the seal jaw shown in FIG. 9 according to embodiments of the present invention.

FIG. 12 is a digital photograph of a side perspective view of an upper heater block release mechanism as viewed from the rear of the automated system shown in FIG. 1A, illustrating the heater block in operative engagement with components of the system according to some embodiments of the present invention.

FIG. 13 is a digital photograph of a rear view of the upper heater block release mechanism shown in FIG. 12 in the automated system shown in FIG. 1A, illustrating the upper heater block released and rotated according to embodiments of the present invention.

FIG. 14 is a digital photograph close-up side perspective view of an integrated film guide and air cooling system in the system shown in an automated system such as that shown in FIG. 1A, illustrated without a film specimen, according to yet other embodiments of the present invention.

FIG. 15 is a digital photograph close-up side perspective view of the integrated film guide and air-cooling system shown in FIG. 14, illustrating a film specimen in position for testing according to embodiments of the present invention.

FIG. 16 is a schematic of a data processing system according to embodiments of the present invention.

### DETAILED DESCRIPTION OF EMBODIMENTS OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise. In the figures, the below reference numbers refer to the defined component(s). The description is based on a three-bay tester (three testing stations), however, lesser or greater numbers of testing stations can be used. Herein, the following reference numbers are used to identify specific components.
10—Reaction frame side (qty 2)
12—Reaction frame top
14—Reaction frame bottom
16—Peel grip assembly (qty 3)
18—Peel grip assembly U-bracket (qty 3)
20—Peel force transducer (qty 3)
22—Upper modular side-insertion peel clamp (qty 3)
24—Lower modular side-insertion peel clamp (qty 3)
26—Film specimen positioning clip (qty 6)
28—Finger recess (qty 6)
30—Film specimen
32—High-speed motion servo
34—High-speed motion arm
36—Closed-loop pressure regulator valve
38—Seal air cylinder (qty 3)
40—Seal jaw (qty 6)
42—Seal jaw clip (qty 6)
44—Heater block (qty 6)
46—Upper heater block spacer (qty 3)
48—Upper heater block release knob (qty 3)
50—Upper heater block release threaded rod (qty 3)
52—Upper heater block release slot (qty 3)
54—Integrated film guide and air cooling system
56—Folding assembly

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

The packaging film that can be evaluated using methods and devices contemplated by the instant invention can be a single ply or multiple ply material. The film can be laminated. The film can be elastomeric. The film can comprise a polymer, copolymer or blend or derivative thereof. The film can also comprise foil or other materials. The test specimens are typically provided as a single elongate strip of the film. The test specimens can be between about 10 to 12 inches long, with a width between about 0.4 to 1.6 inches, typically about 1.0 inch. The test specimens should be prepared in sufficient quantity to run them through all desired testing temperatures. The test specimens should be oriented with the seal surface facing in the same direction (typically facing the operator) for insertion/loading and/or testing in the system.

The term “automated” means that the operations are carried out without requiring operator assistance or input. The term “semi-automated” means that the device is programmatically and electronically configured to perform the operations substantially without manual labor but may accept user input to select functions, load and unload film, and the like.

The systems can be configure to carry, out a plurality of different tests, typically including three basic tests that can be automatically or semi-automatically performed using automated systems which are generally described below. It is noted that the automated systems can be configured to perform lesser or greater number of tests, either per specimen and/or per automated system.

Hot Tack Test

The Hot Tack Test measures the strength of a heat seal at a short time interval after a seal is made and before it has cooled down to its peak strength. This is an indicator of the seal's ability to withstand the stress of the product filling operation during manufacturing, when the seal may not be (and typically is not) fully cooled and at full strength. This test can be performed by:

a) folding a strip of specimen film back on itself to form two layers of film,

b) sealing those two layers together (simulating a pouch or bag seal) by applying pressure to the folded layers between two seal jaws or dies, typically under controlled conditions of pressure, temperature and duration,

c) releasing the seal die pressure,

d) (quickly) extracting the sealed specimen from the dies, then peeling the sealed section apart while measuring the peel force to do so,

e) recording the pulling forces at specific time intervals from extraction from the dies, which are typically at between about 0.25 second to about 0.50 second intervals, then

f) repeating the above tests with different specimens at specific temperature steps in order to create a graph or curve of the film's hot tack strength vs. temperature. The graph or curve can be electronically generated and/or displayed and/or printed in a report.

Heat Seal Test

The Heat Seal Test measures the strength of a heat seal after it has cooled to ambient temperature and has reached stability. This is an indicator of the seal's ability to withstand the packaging stresses found in handling and distribution. This test is done by:

a) folding a strip of specimen film back on itself to form two layers of film,

b) sealing those two layers together (simulating a pouch or bag seal) by applying pressure between two seal dies under controlled conditions of pressure, temperature and duration,

c) releasing the die pressure,

d) extracting the sealed specimen from the dies,

e) cooling the recently formed seal to ambient temperature, typically by directing fluid, such as ambient or cooled air, over and/or under the seal region in the film,

f) peeling apart the sealed section while substantially continuously measuring the force to do so,

g) recording the peak force measured during the peel operation, and

h) repeating the above tests with different specimens at specific temperature steps in order to create a curve of the film's peak strength vs temperature. The graph or curve can be electronically generated and/or displayed and/or printed in a report.

Aged Seal Test

The Aged Seal Test measures the strength of a heat seal after a prolonged time period (thus the term “aged”). The time period is typically days, weeks, or even months. This is an indicator of the seal's ability to maintain strength over long periods of time and thus preserve product freshness. The Aged Seal Test can be considered a variation of the Heat Seal Test, with the difference being a longer time period between sealing and peeling apart the specimen seal. This test can be done by:

a) folding a strip of specimen film back on itself to form two layers of film,

b) sealing those two layers together (simulating a pouch or bag seal) by applying pressure between two seal dies under controlled conditions of pressure, temperature and duration,

c) releasing the die pressure,

d) extracting the sealed specimen film from the dies,

e) storing the sealed specimen film for a target extended time period (or aging the specimen to represent the target time period),

f) repeating the above sealing operations (a-e) with different specimens at specific temperature steps and storing the sealed specimens for the required extended time,

g) then, for each aged specimen, peeling apart the sealed section while substantially continuously measuring the force to do so,

h) for each aged specimen, recording the peak force measured during the peeling operation, and

i) for one or a set of aged specimens, creating a curve of the film's peak strength vs. temperature. The graph or curve can be electronically generated and/or displayed and/or printed in a report.

Reaction Frame

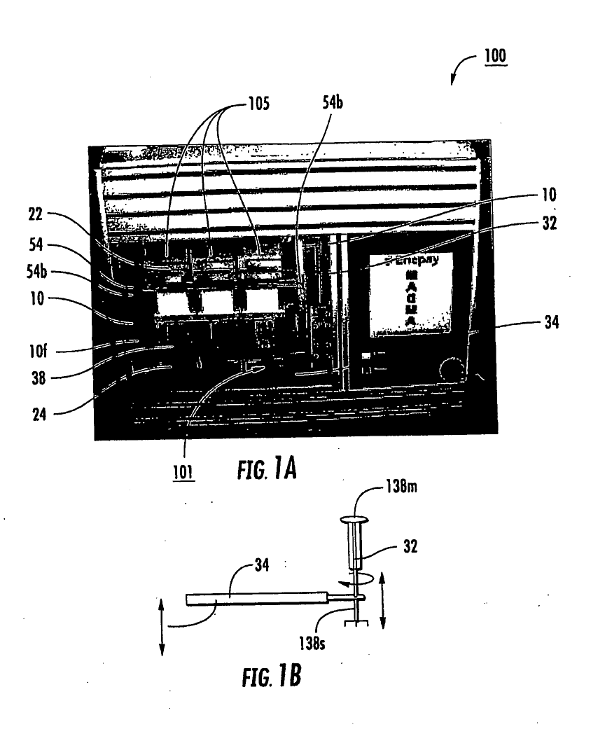

As shown in FIGS. 1A, 2 and 3 the automated testing system 100 can include a reaction frame platform 10r with sides 10, a reaction frame top 12 and a reaction frame bottom 14. The reaction frame platform 10r can provide a rigid mounting frame body to which other mechanical components are mounted. In the embodiment shown, there are three side-by-side testing bays or stations 105. The systems 100 can include greater or lesser numbers.

Peel-Grip Assemblies

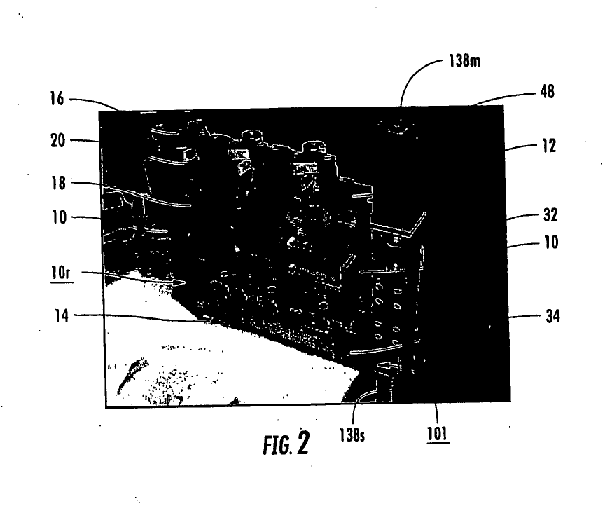

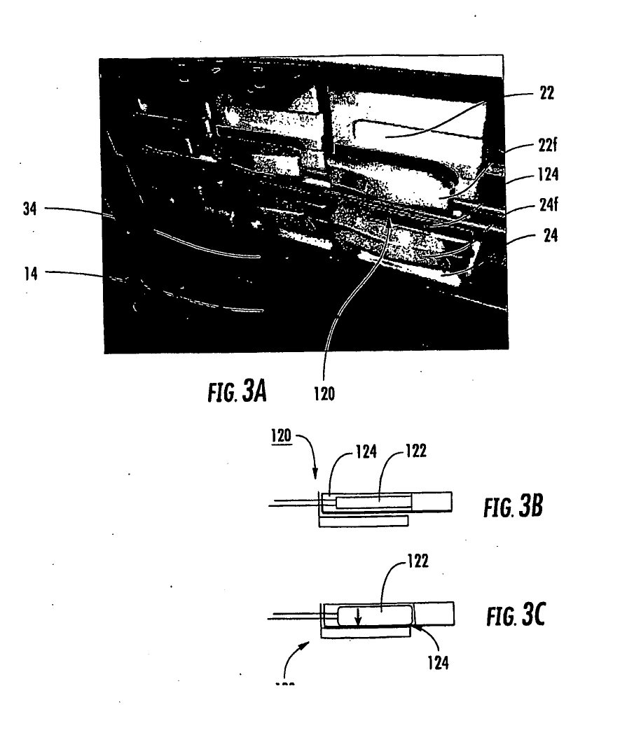

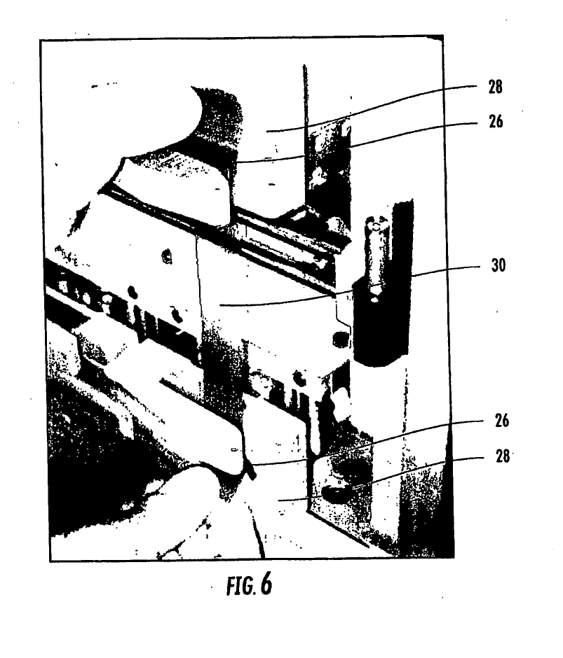

Referring to FIGS. 2 and 3 the (three) peel grip assemblies 16 provide several functions. The peel grip assemblies 16 can each include a peel grip assembly U-bracket that releaseably attaches cooperating upper and lower peel clamp modules 22, 24 to reaction frame 10r, and a peel force transducer 20. The upper and lower modular subassemblies 22, 24 can each include a respective heating seal jaw 40 (also known as a sealing die), a heater block 44, side entry peel clamp 22f (upper) or 24f (lower), and a film specimen positioning clip 26 with optional finger recess 28. The peel grip assemblies 16 can be configured so that the upper side-insertion peel clamp module 22 and the lower side insertion clamp module 24 allow a film specimen 30 (FIG. 6) to be loaded into the system 100 in a single step by simply sliding in from the side (where side entry sliding peel clamp fingers 22f, 24f are used). Also, the peel grip assemblies 16 grip the film specimen 30 for peel testing by applying pressure to the film with the upper modular side-insertion peel clamps 22. Further, the peel grip assemblies 16 measure the peel force exerted on the specimen 30 as the seal is peeled apart with their peel force transducers 20.

Modular Side-Insertion Peel Clamps

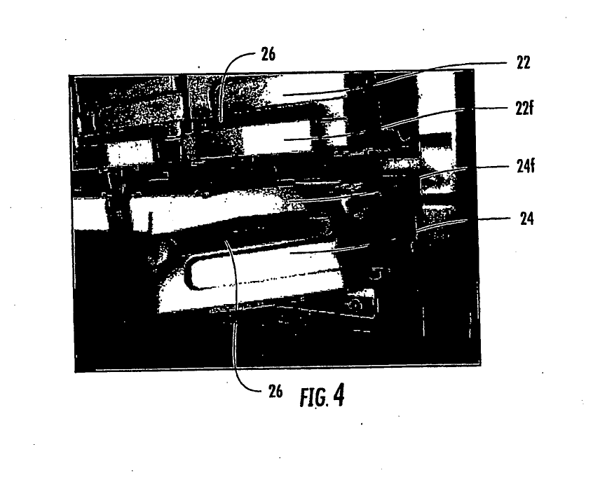

Referring to FIGS. 3A and 4, some embodiments of the invention incorporate side-insertion peel clamps 22, 24 that may be modularly configured so as to be releasably attached to the reaction frame 10r. The peel clamps 22, 24 include aside entry finger 22f, 24f with a cooperating fluid clamping mechanism 120. As shown schematically in FIGS. 3B and 3C, the fluid clamping mechanism 120 includes an internal resilient elastomeric expander 122 that expands to force a substantially rigid member 124 to automatically laterally translate outward to clamp or pinch against respective finger 22f, 24f to hold a film specimen 30, then automatically releases the expansion medium to compress to release the film 30. The elastomeric (typically polymeric) expander 122 can be an inflatable balloon that resides inside a laterally floating channel. The expansion medium or fluid can be gas and/or liquid and is typically air. Although shown as being directed into the expander 122 from a lateral direction, the expansion fluid can be directed into the expander 122 from any suitable direction.

As shown in FIGS. 3A, 4 and 6, the side-insertion peel clamps 22, 24 provide for fast loading of film samples by allowing the operator to simply slide film samples into the open side of the peel clamps. The side-insertion peel clamps 22, 24 do not require latches, doors, other clamps or other devices to hold film samples during the peeling operation. Not having to operate doors and latches can increase the speed of loading specimens into the system. Also, not having to operate doors and latches eliminates the risk of faulty data from grip slippage as a result of the operator not adequately latching the front doors. Finally, the side-insertion peel clamps 22, 24 can be configured to eliminate a number of moving parts and therefore increase machine reliability. The side entry fingers 22f, 24f in FIG. 4 can be a unitary body with a closed side and an open side that provides for insertion of the specimen from the right. Alternative embodiments can include one or more of:

a) a releasable attachment means (such as bolting, bayonet fitting, or other attachment means) on the closed end of the side entry fingers 22f, 24f in FIG. 4 for removing the entire member or the cantilevered section for servicing or replacement;

b) reversing the orientation to allow insertion from the left side; and/or

c) employing a different (automatic) releasable clamp/film attachment mechanism that cooperates with the finger clamp to reliably secure the film during testing.

In some embodiments, the peel clamps 22, 24 can be configured as peel clamp modules 22, 24 that can be configured for easy removal for servicing or replacement. The peel clamp modules 22, 24 may be mirror images of each other, one configured for an upper operating portion and the other a lower operating position. Easy removal for servicing may be desirable to adjust, repair or replace all or a portion of the internal fluid (typically pneumatic) clamping mechanism 120. Modularity and easy removal is accomplished through separating the side-insertion peel clamp from its mating mounting assembly and using a releasable mechanical attachment member to attach the side insertion peel clamp modules 22, 24 to the reaction frame 10r. The mechanical attachment member can be a single fastener or multiple fasteners, such as single bolt, a bayonet quick connect, a press fit or other suitable releasable attachment means.

Film Specimen Positioning Clip and Finger Recess

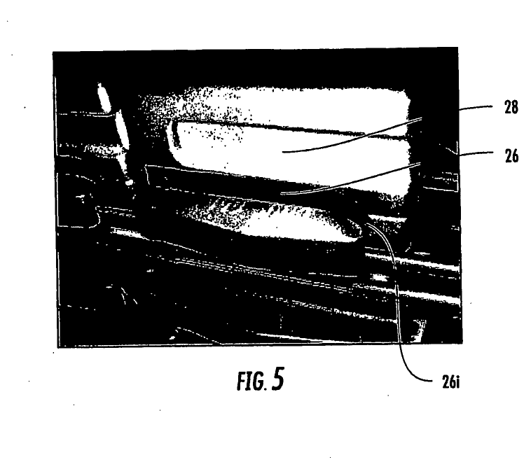

Referring to FIGS. 5 and 6, the automated system 100 can include at least one film specimen positioning clip 26 for each peel grip assembly 16 to hold at least one end portion of the specimen 30 in position until the fluid-activated clamping mechanism 120 of the modular side-insertion peel clamps 22, 24 energizes and/or expands to grip the specimen 30 for a test (such as a peel test). The clip 26 can be configured as an elongate spring clip that abuts a rigid substrate to be able to snugly pinch the film to hold it in position.

Typically, the systems 100 include both an upper and lower film positioning clip 26, which as shown, are vertically aligned to allow an operator to slide the film into position into all three open side entry film holders substantially concurrently using a single slide entry movement. However, multiple clips can be disposed above and multiple clips may be disposed below the respective primary peel grips. Where a single clip 26 is used, it may be desirable to position it above the peel testing location.

As shown, the film specimen positioning clip 26 can be located adjacent to the side-insertion peel clamp fingers 22f, 24f and can be shaped with a curved profile with an outwardly extending open lead-in edge at the end 26i to allow an operator to easily insert the specimens from the side without requiring the operator to pull the clip outward or push it inward to hold the specimen. The clips 26 can comprise spring steel, ceramic, composite, elastomeric or other suitable material that can provide a clamping force that allows film specimens 30 to be inserted from the side yet that is structurally strong and/or rigid enough to hold the specimens in place at least until the fluid-activated peel clamps 120 energize.

Referring to FIGS. 5 and 6, the finger recess 28 adds further operator convenience during specimen insertion by providing an optional space behind (and above or below) the film specimen positioning clip 26 for the operator's fingers to guide the film specimen 30. Additionally, the finger recess 28 may reduce the likelihood of the operator pressing inward on the upper modular side-insertion peel clamps 22 during specimen insertion and thus reduces the probability of the sensitive peel force transducer 20 (FIG. 2), which is attached to the upper modular side-insertion peel clamps 22 via the peel grip assembly U-bracket 18 (FIG. 2), from being damaged from overly high side loads.

The film specimen positioning clip 26 (and optional finger recess 28) allows the operator to simply hold top and bottom end portions of a film specimen 30 and insert it into the system 100 with a single (sideway) motion. This is much faster than other designs, which use combinations of doors and latches to hold the specimen ends, and results in less operator fatigue during repeated use of the test system. It is noted that, although shown as oriented with the open entry end to the right, the film specimen positioning clip 26 can be configured to allow insertion from either the left or right side and, similarly, the finger recess 28 may be oriented for insertion of the film from either the left or right side. Although the recess 28 is shown as a shallow substantially planar “U” shaped channel, other recess geometries (depth, length, width, shape) may be used.

High-Speed Motion Assembly

Referring to FIGS. 1A, 1B and 2, the automated system 100 can include a high-speed motion assembly 101 that includes a high-speed motion servo 32 and high-speed motion arm 34, and provides the downward peeling motion for the peel testing of the sealed specimens 30. The high-speed motion servo 32 can include a 200-Watt motor 138m coupled to a lead screw 138s. Other motor ratings may be used. The three lower side insertion peel clamp modules 24 can be mounted to the high-speed motion arm 34 so that the lower peel clamp modules 24 move in concert in response to translation of the screw 138s. Otherwise, the lower modular side-insertion peel clamps 24 can operate substantially identically as the upper modular side-insertion peel clamps 22 as discussed herein. The high speed motion arm 34 can be a planar “L” shaped plate that is configured as a lever arm (cantilevered) that extends off the screw 138s as shown in FIG. 2. In other embodiments, the other end of the arm may be supported in a passive manner to allow up and down movement rather than a cantilever design (such as via sliders, rollers, bearings, or the like).

The high-speed motion arm 34 can be driven by the lead screw 138s at a user- and/or test-selected speed. In some embodiments, the speed may be selected by the operator through the software at the beginning of a test or test sequence. Because the lower side-insertion peel clamp modules 24 are mounted to this common high-speed motion arm 34, all three film specimens 30 can be peel-tested at precisely the same speed. Although described with respect to a motor and screw, other electro-mechanical drive systems may also be employed, such as a linear motor, chains, belts, fluid actuators and the like.

The high-speed motion arm 34 can reside in (or travel to) one of three positions, depending on the test step. The first position is the “load” position where the arm 34 is typically at its lowest position and farthest from the upper modular side-insertion peel clamps 22; this is the location used to load specimens in preparation for some of the testing. The next position is the “sealing” position where the arm 34 is at its highest position and closest to the upper modular side-insertion peel clamps 22; this is where the specimens 30 have been pulled through the seal jaws 40 and are being sealed. Finally, the third position in the test sequence is the “peel test preparation” location; this is where it is approximately at mid-position after having extracted the specimens 30, either in preparation for the peeling test or waiting for specimen removal in the case of aged seal tests.

The high-speed motion assembly 101 may be configured with a maximum speed between about 300-1000 mm/sec. In some embodiments, the high-speed motion assembly 101 can operate with a maximum speed of at least about 600 mm/sec, which is faster than known previous peel motion arm designs, which had a maximum speed of about 300 mm/sec. This allows the high-speed motion assembly to serve two functions: a) fast extraction of the sealed specimens from the seal jaws 40 at a high speed, and b) slowing down quickly to a lower speed and peeling the sealed specimens apart during which peel forces are measured. By performing the fast extraction function, the high-speed motion arm 34 eliminates the need for a position assembly found in other designs. Eliminating the position assembly with its positioning clamps and latches may be advantageous, because these components may be costly to manufacture, labor intensive to assemble, difficult to use, difficult to service, and/or noisy in operation.

Seal Jaws

The automated system 100 can include a pair of cooperating upper and lower seal jaws 40 for each station that heat to a sealing test temperature that can be pre-set in the test parameters. In some conventional designs, the three upper seal jaws 40 are attached to seal force transducers (different from the peel force transducers 20), which are in turn mounted to the reaction frame top 12. In some embodiments of the invention, the lower seal jaws 40 can be affixed to a respective one of three fluid cylinders 38 (typically pneumatic cylinders), which move upward in unison at a controlled pressure to seal against the upper seal jaw 40. The seal pressure is applied for the specified dwell time, then released.

Seal Jaw Pressure Control

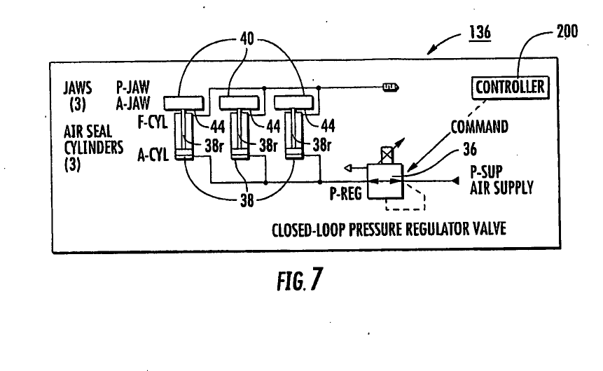

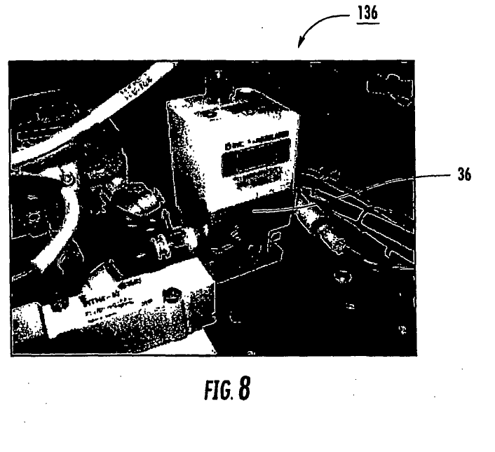

As shown in FIGS. 7 and 8, some embodiments of the invention can utilize a high-precision closed-loop pressure regulation system 136 that includes a regulator valve 36 in conjunction with seal air cylinders 38 to control the sealing pressure exerted on the specimens at the seal jaws 40. In an exemplary embodiment, an analog voltage Command is sent from the system controller 200 to the closed-loop pressure regulator valve 36 to output the regulated pressure P-reg. P-reg acts across each piston of seal air cylinders 38; given the known piston area A-cyl, the resulting force F-cyl is calculated by F-cyl=P-reg×A-cyl. Since the seal jaw 40 with jaw surface area A-jaw is attached to the cylinder rod 38r via the heater block 44, the force F-cyl creates seal jaw 40 pressure P-jaw according to P-jaw=F-cyl/by A-jaw. Thus, a simple mathematical relationship can be established between the value of the analog voltage Command and the resulting seal jaw 40 pressure P-jaw. The closed-loop pressure regulator valve 36 is linear and highly repeatable. Thus, the linearity and repeatability are both within 1% of full scale of the valve's range.

The pressure regulator can be an electro-pneumatic regulator, with a stepless control of air pressure proportional to an electrical signal with suitable sensitivity, such as about 0.2 kPA (100 kPA specifications), within +/−1% linearity (F.S.) and within about 0.5% hysteresis (F.S). An example of a suitable regulator is the ITV 1000/2000/3000 series, such as the ITV 2050-01N2N4 from SMC, Corporation, having U.S. headquarters in Indianapolis, Ind. Other models or suppliers of pressure regulators may also be used. Also, the seal air cylinders 38 must have low friction rod bearings and seals to minimize errors in producing the desired seal jaw 40 pressure P-jaw. Thus, the seal air cylinders 38 are of special low-friction design with static frictions of less than 4 psi and with dynamic frictions even lower. Suitable cylinders are made by SMC Corporation, such as, for example, model number is CDQ2A32-40DC. Other makes, models and suppliers can also be used.

The use of pressure transducers, instead of load cells, in heat seal and hot tack to control seal jaw pressure is believed to be unique in the industry. Most other known heat seal and hot tack test systems use a strain-gaged load cell to measure the seal jaw forces (and thus seal jaw pressures) at each station. Such load cells require periodic calibrations and are typically located “deep” inside the test system; performing the calibrations is therefore often a time-consuming and, thus, costly operation. In contrast, the closed-loop pressure system 136 with regulator valve 36 requires less frequent calibrations and is easy to access when calibrations are needed. Also, for a test system with multiple test stations, having multiple load cells with their associated conditioning electronics is more costly than is one with the novel closed-loop pressure regulator valve 36.

In summary, the use of a high-precision closed-loop pressure systems 136 with a regulator valve 36 in conjunction with seal air cylinders 38 can provide for less frequent and easier calibrations, and is less expensive to produce.

It is noted that the exemplary system can be modified in a number of ways such as, for example, the use of multiple components to provide the same functionality as the single closed-loop pressure regulator valve 36 described herein. This includes the use of a separate pressure transducer in conjunction with a separate closed-loop controller. The controller 200 can be configured to use a digital Command instead of or with an analog Command signal. The closed-loop pressure regulator valve 36 can have different operating specifications such as linearity and repeatability. The seal air cylinders 38 can have different operating specifications such as static and dynamic friction.

Seal Jaw Clip

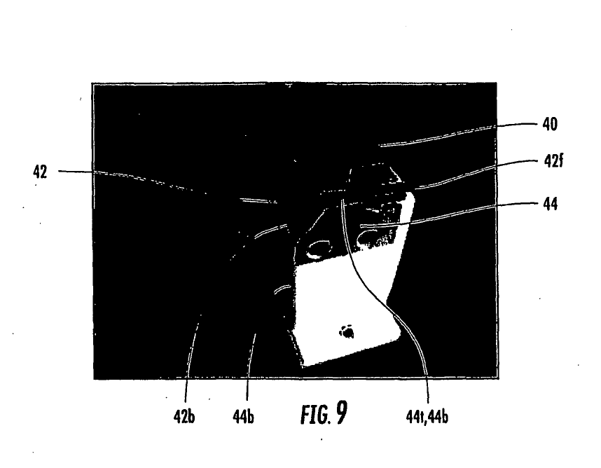

As shown in FIGS. 9, 10 and 11, the automated system 100 shown in FIG. 1 can include heater a replaceable seal jaw 40 that releasably mounts to the heater block 44 with at least one seal jaw clip 42. The seal jaw clip 42 can be a resilient member that pushes against the block 44. The seal jaw clip 42 can comprise a single piece of resilient formed spring steel sheet with a laterally extending back segment 42b that attaches to the rear of the heater block 44b and two outwardly extending hold-down fingers 42f coming forward from the back section. The transition from the back segment 42b to hold-down fingers 42f is shaped so as to create tension and exert pressure against the top of the heater block 44t. (Or “bottom” of the heater block 44b for the upper heater blocks 44.) This downward (or upward) pressure holds the jaw 40 in place against the block 44 after the operator inserts it. Although described as a unitary body, the seal jaw clip 42 can comprise multiple pieces. In addition, more than one finger may be disposed on one or each end portion or the clip finger may reside only on a single end portion and clamp with sufficient force to hold the jaw 40 in position during operation. Other geometries, thicknesses, scale and dimensions can be used to hold the fingers to the block 44 and/or to define the fingers 42f.

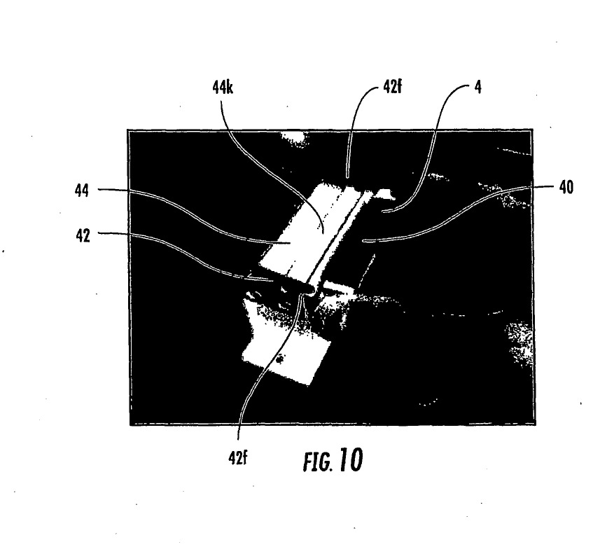

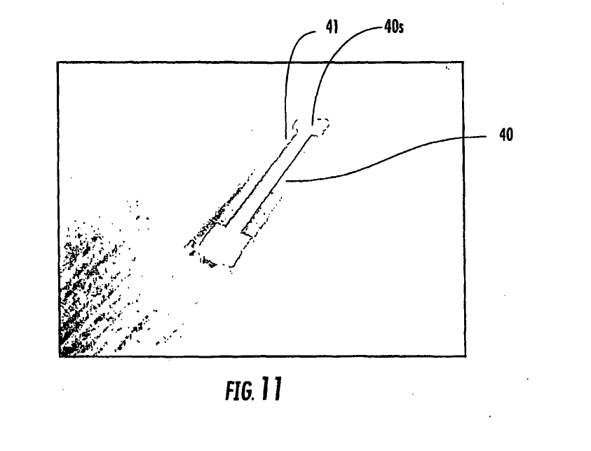

Each finger 42f protrudes some distance beyond the front of the heater block 44 so the operator can easily “feel” engagement of the jaw 40 against the fingers 42f as the jaw 40 is placed under the front of the fingers, lifting the fingers 42f slightly and sliding the jaw 40 rearward onto the top surface of the heater block 44. The jaw 40 may also include a TEFLON or other anti-stick coating 41 or material on its surface as shown in FIGS. 10 and 11.

As shown in FIG. 10, the heater block 44 can include a lateral protrusion or key 44k which mates with a slot 40s in the underside of the jaw 40. The combination of key and slot provides positive and accurate front-to-back positioning of the jaw as it is inserted. The key can alternatively be formed on the jaw 40 and the slot on the heater block 44 or other positive alignment configurations may be used.

The (side to side) length of the jaws can be slightly greater than the (side to side) length of the heater blocks 44 to allow the operator to easily hold the jaws 40 by holding them at their ends during removal and insertion.

The seal jaw clips 42, together or separate from the matable alignment features (key and slot features), can provide a simple changeover of seal jaws 40 for the operator, requiring no tools and just seconds of time. This is a significant improvement over other configurations, which can require tedious loosening and tightening of fasteners in cramped working spaces.

Upper Heater Block Release Mechanism

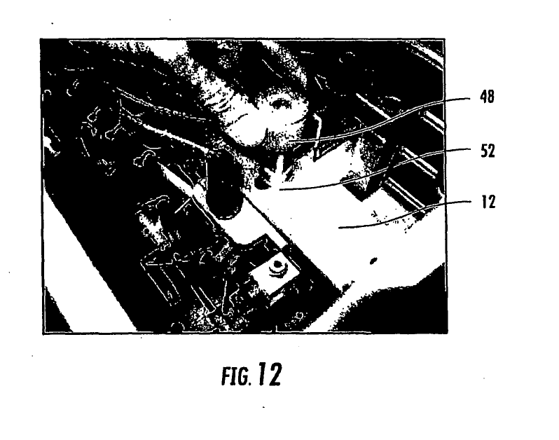

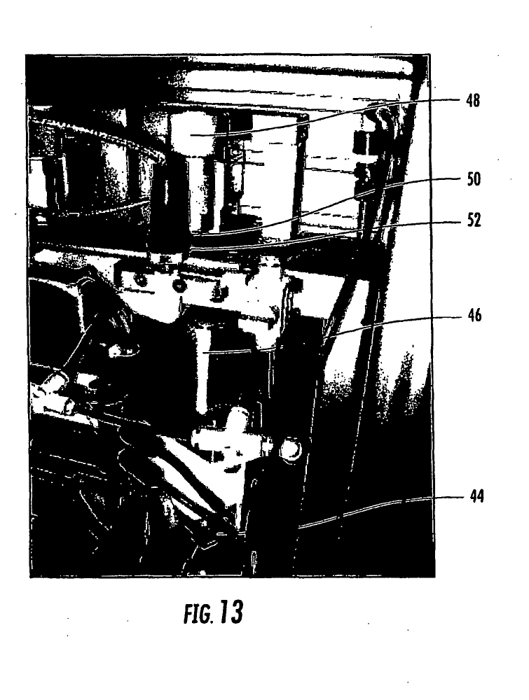

As shown in FIGS. 12 and 13, upper heater block 44 is connected to upper heater block spacer 46. From the top of upper heater block spacer 46 extends the upper heater block release threaded rod 50 that reaches through an upper heater block release slot 52 in the reaction frame top 12 and threads into the upper heater block release knob 48. By turning the upper heater block release knob 48 the operator is able to lower the upper heater block spacer 46 and upper heater block 44 in a controlled fashion, then turn the heater block spacer and upper heater block 44 so as to access and service the removable heaters and temperature transducers in the heater block 44. Reversing the process raises the upper heater block spacer 46 and upper heater block 44 into their original, engaged position in a machined pocket in the reaction frame top 12.

The benefit of this mechanism is the ease with which operators can release and rotate the upper heater block 44 to perform needed service work, with no tools required in the process.

Alternative embodiments include, for example:

a) Use of other attachment members, such as, but not limited to, a wing nut or other threaded device in place of the knurled knob; and

b) Other geometries for the opening in the reaction frame top 12 in place of the upper heater block release slot 52.

Integrated Film Guide and Cooling System

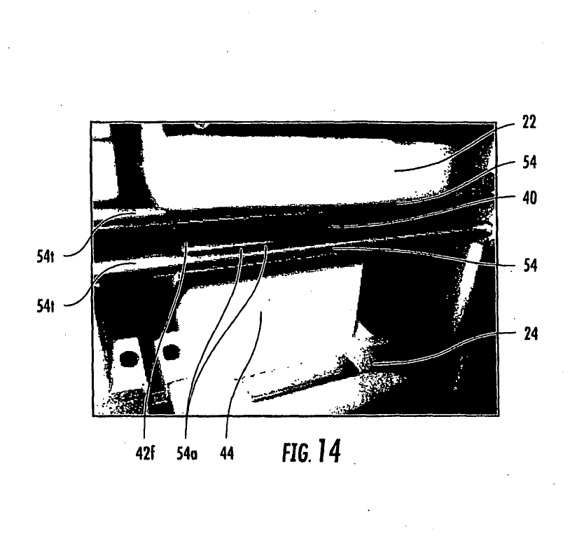

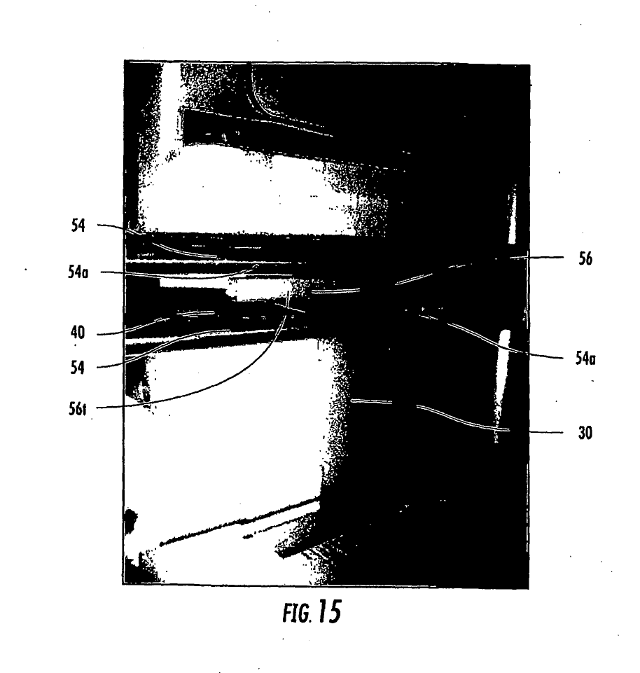

As shown in FIGS. 1A and 3, the automated system 100 can include an integrated film guide and cooling system 54. FIGS. 14 and 15 show that the system 54 can include two substantially parallel stainless steel tubes 54t, one above the other, running between the upper and lower side-insertion peel clamp modules 22, 24 with a length sufficient to extend across each of the testing stations. The tubes 54 can act both as film guides and to direct fluid to the film to cool the film specimen in each bay or station during testing.

Each tube 54t is perforated or configured with a series of small apertures 54a clustered proximate each of the three testing stations; each series of apertures 54a can be oriented (directed to spray and/or expel air or other fluid) in any suitable direction, such as, for example, toward the opposite tube (i.e., the upper tube apertures can face generally downward and the lower tube apertures can face generally upward). In other embodiments, the fluid, gas (typically air) is not required to be directed toward the opposite tube. In some embodiments, the tubes can be independently rotated to direct the fluid (e.g., air) up, down, out, or any angle, depending on the best cooling for the specimen. The rotational orientation of the holes in each tube may be different (e.g., the top might blow straight out and the bottom might blow downward). The rotational angle can be set (fixed) during system assembly, and may optionally be adjustable by test selection or by an operator during operation of the system. In some embodiments, the left end portion of the tubes can be open and in fluid communication with the fluid coolant source while the right end portions can be sealed closed. The same or a different fluid can be directed to flow out of each tube.

As shown in FIG. 1A, the pair of tubes 54 can be affixed to the reaction frame 10f. In some embodiments, the tubes 54 can be captured at both ends by brackets 54b. The left bracket can be held in a pocket in the left reaction frame side 10 and can serve to: a) hold the pair of tubes 54 firmly in place as film specimens 30 are pulled across them, and b) feed air from the system air supply (or a dedicated coolant supply source) to the open ends of the tubes, then to the apertures 54a or perforated holes for specimen cooling. In some embodiments, the left end portion of the tubes can be pivotably mounted to the frame side 10 such as via a hinge to allow the integrated film guide and air cooling system 54 to swing away to the left to allow front access to service the (upper and lower) seal jaws 40. The right bracket can be captured in a pocket in the right reaction frame side 10 and can serve to: a) hold the pair tubes 54 firmly in place as film specimens 30 are pulled across them during automated testing and b) provide a light latching or locking action to hold itself in place on the frame 10f until an operator pulls it out of the pocket.

As noted above, the integrated film guide and cooling system 54 can serve two purposes. First, as shown in FIG. 15, it guides the specimen films 30 through the upper and lower seal jaws 40 as the specimens are pulled rearward by the film folding assembly 56. Second, it directs cooling fluid, typically gas, and more typically air at each station to the specimen film after it has been sealed and before it is peeled. The fluid can be at ambient temperature or may be cooled.

The benefits of the integrated film guide and cooling system 54 include: a) its compact design, fitting between the upper and lower side-insertion peel clamp modules 22, 24, b) hinged capability, allowing it to be easily swung away for servicing, and c) low cost, combining two important functions (guiding and cooling) into one component.

Some alternative embodiments include:

a) The hinge function being located on the right instead of the left.

b) Tubes made from materials other than stainless steel.

c) More than two parallel guide tubes (i.e., a plurality at an upper and a plurality at a lower.

Folding Assembly

Referring to FIG. 15, film-folding assembly 56 has three tines 56t that move in-concert to “hook” the three film specimens 30 and pull a respective specimen back between the respective upper seal jaws 40 and lower seal jaws 40 at each station 105 in preparation for the sealing operation. The folding assembly 56 moves the tines 56t in two axes in a substantially horizontal plane. During the test, the folding assembly 56 first moves laterally to one side, then moves forward between the upper and lower modular side-insertion peel clamps 22, 24 and past the vertical plane defined by the three specimens 30. It then moves laterally in the opposite direction to bring the three tines 56t in front of the three film specimens 30. At the point in the test when the specimens 30 are to be sealed, folding assembly 56 moves toward the rear. In this way the specimens 30 are pulled through (essentially “folded” back on itself, thus the name of the assembly) the upper and lower seal jaws 40. The folding assembly 56 remains in this position until the seal is formed, and thereafter moves laterally to release the newly-sealed specimens.

Software and Controls

General

The test sequence can be automated from the time that the operator initiates or selects a test to the time that the test is complete and its results are displayed. Through a graphical user interface (GUI), test profiles can be created and saved, engineering units selected, default test directory paths set, tests initiated, observations entered during testing, data tabulated and graphed for each group of three specimens, data saved, data exported, data recalled and displayed, transducers calibrated, and many other functions performed.

Exemplary Test Sequences

Test Type 1

The invention may operate in the following sequence for Hot Tack Tests, Heat Seal Tests, and for the initial sealing operation in Aged Seal Tests:

a) Operator inputs test parameters.

b) Operator loads specimens 30 by inserting them into the upper and lower film specimen positioning clips 26.

c) Operator starts automated test.

d) Modular side-insertion peel clamps 22, 24 energize to grip the specimens.

e) Upper and lower seal jaws 40 heat up to the specified temperature.

f) Folding assembly 56 moves forward to front of specimens 30.

g) Simultaneously, the high-speed motion arm 34 moves from “load” position to “sealing” position, and folding assembly 56 moves rearward, thereby pulling specimens 30 between upper and lower seal jaws 40.

h) Lower seal jaws 40 move up to the upper seal jaws 40 at the specified pressure and for the specified dwell time, thereby sealing specimens 30.

i) Folding assembly 56 moves laterally to release the specimens 30.

j) Lower seal jaws 40 retract and release the specimens 30.

k) High-speed motion arm 34 moves to the “peel test preparation” location.

Either (in the case of sealing specimens 30 for Aged Seal testing):

l) Modular side-insertion peel clamps 22, 24 release the specimens.

m) Operator removes specimens 30 and sets them aside for aged seal testing later.

n) Test is over.

o) Test can be repeated at new temperature.

Or (in the case of a Hot Tack or Heat Seal test):

l) High-speed motion arm 34 switches to the operator-requested test speed and performs the peeling test by moving down at the specified test rate.

m) Force data is simultaneously collected with the peel force transducers 20.

n) Upon completion of peeling test, data is displayed and stored.

o) Modular side-insertion peel clamps 22, 24 release the specimens.

p) Operator removes specimens 30.

q) All assemblies are moved to initial positions.

r) Test can be repeated at new temperature.

Test Type 2

The device can operate in the following sequence for the final peeling test in Aged Seal Tests:

a) Operator inputs test selection/commands via the user interface, causing high-speed motion arm 34 to move to the “peel test preparation” position.

b) Operator loads specimens 30 by inserting them into the upper and lower film specimen positioning clips 26, while keeping the sealed section located between the upper and lower modular side-insertion peel clamps 22, 24.

c) Operator starts automated test.

d) Modular side-insertion peel clamps 22, 24 energize to grip the specimens.

e) High-speed motion arm 34 performs the peeling test by moving down at the specified test rate.

f) Force data is simultaneously collected with the peel force transducers 20.

g) Upon completion of peeling test, data is displayed and stored.

h) Modular side-insertion peel clamps 22, 24 release the specimens.

i) Operator removes specimens 30.

j) All assemblies are moved to initial positions.

k) Test can be repeated at a new temperature.

As will be appreciated by one of skill in the art, embodiments of the invention may be embodied as a method, system, data processing system, or computer program product. Accordingly, the present invention may take the form of an entirely software embodiment or an embodiment combining software and hardware aspects, all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic or other electronic storage devices.

Computer program code for carrying out operations of the present invention may be written in an object oriented programming language such as Java, Smalltalk or C++. However, the computer program code for carrying out operations of the present invention may also be written in conventional procedural programming languages, such as the “C” programming language or in a visually oriented programming environment, such as VisualBasic.

Certain of the program code may execute entirely on one or more of the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider). In some embodiments, some program code may execute on local computers and some program code may execute on one or more local and/or remote server.

The invention is described in part below with reference to flowchart illustrations and/or block diagrams of methods, systems, computer program products and data and/or system architecture structures according to embodiments of the invention. It will be understood that each block of the illustrations, and/or combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory or storage that can direct a computer or other programmable data processing apparatus to function in a particular manner, such that the instructions stored in the computer-readable memory or storage produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

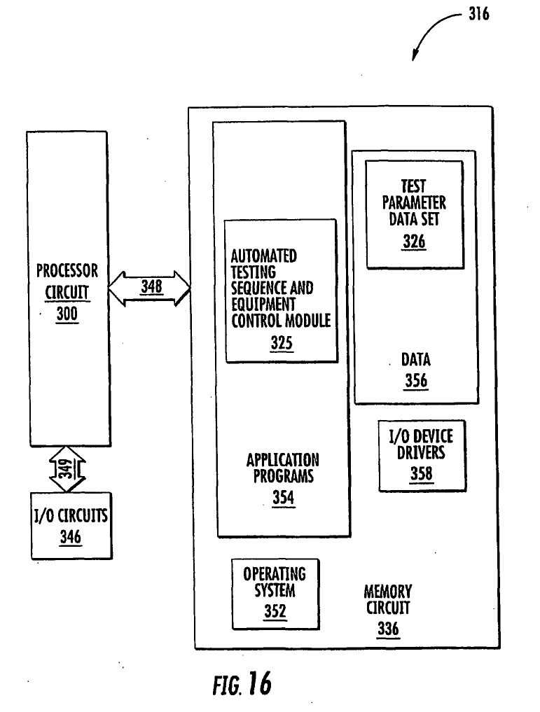

As illustrated in FIG. 16, embodiments of the invention may be configured as a data processing system 316, which can be used to carry out or direct operations of the rendering, and can include a processor circuit 300, a memory 336 and input/output circuits 346. The data processing system may be incorporated in, for example, one or more of a personal computer, workstation 316, server, router or the like. The system 316 can reside on one machine or between a plurality of machines. The processor 300 communicates with the memory 336 via an address/data bus 348 and communicates with the input/output circuits 346 via an address/data bus 349. The input/output circuits 346 can be used to transfer information between the memory (memory and/or storage media) 336 and another computer system or a network using, for example, an Internet protocol (IP) connection. These components may be conventional components such as those used in many conventional data processing systems, which may be configured to operate as described herein.

In particular, the processor 300 can be commercially available or custom microprocessor, microcontroller, digital signal processor or the like. The memory 336 may include any memory devices and/or storage media containing the software and data used to implement the functionality circuits or modules used in accordance with embodiments of the present invention. The memory 336 can include, but is not limited to, the following types of devices: ROM, PROM, EPROM, EEPROM, flash memory, SRAM, DRAM and magnetic disk. In some embodiments of the present invention, the memory 336 may be a content addressable memory (CAM).

As further illustrated in FIG. 16, the memory (and/or storage media) 336 may include several categories of software and data used in the data processing system: an operating system 352; application programs 354; input/output device drivers 358; and data 356. As will be appreciated by those of skill in the art, the operating system 352 may be any operating system suitable for use with a data processing system, such as IBM®, OS/2®, AIX® or zOS® operating systems or Microsoft® Windows®95, Windows98, Windows2000 or WindowsXP operating systems Unix or Linux™. IBM, OS/2, AIX and zOS are trademarks of International Business Machines Corporation in the United States, other countries, or both while Linux is a trademark of Linus Torvalds in the United States, other countries, or both. Microsoft and Windows are trademarks of Microsoft Corporation in the United States, other countries, or both. The input/output device drivers 358 typically include software routines accessed through the operating system 352 by the application programs 354 to communicate with devices such as the input/output circuits 346 and certain memory 336 components. The application programs 354 are illustrative of the programs that implement the various features of the circuits and modules according to some embodiments of the present invention. Finally, the data 356 represents the static and dynamic data used by the application programs 354 the operating system 352 the input/output device drivers 358 and other software programs that may reside in the memory 336.

The data 356 may include current or historical film test data sets and/or test parameters associated with different testing regimens 326. As further illustrated in FIG. 16, according to some embodiments of the present invention application programs 354 include an Automated Testing Sequence and Equipment Control Module 325. For example, the clamping of the peel clamps can be timed to inflate the clamping member and/or to initiate subsequent testing sequences. The application program 354 may be located in a local server (or processor) and/or database or a remote server (or processor) and/or database, or combinations of local and remote databases and/or servers.

While the present invention is illustrated with reference to the application programs 354 in FIG. 16, as will be appreciated by those of skill in the art, other configurations fall within the scope of the present invention. For example, rather than being application programs 354 these circuits and modules may also be incorporated into the operating system 352 or other such logical division of the data processing system. Furthermore, while the application program 354 is illustrated in a single data processing system, as will be appreciated by those of skill in the art, such functionality may be distributed across one or more data processing systems in, for example, in a client/server arrangement. Thus, the present invention should not be construed as limited to the configurations illustrated in FIG. 16 but may be provided by other arrangements and/or divisions of functions between data processing systems. For example, although FIG. 16 is illustrated as having various circuits and modules, one or more of these circuits or modules may be combined or separated without departing from the scope of the present invention.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. An automated packaging-film testing system configured to perform at least one of a Hot Tack Test, Heat Seal Test, and an Aged Seal Test, the system comprising at least one of the following components: (a) side-insertion peel clamps that are configured to releasably grip film specimens using a resilient fluid-expandable member that cooperates with a side insertion finger to releasably clamp a film specimen; (b) at least one film specimen positioning clip configured to releasably hold film specimens in position prior to initiation of a test sequence, (c) a motion assembly comprising a single drive system attached to one end portion of an arm that supports and moves all lower seal jaws at each testing station substantially in concert to thereby allow for faster extraction of film specimens from the seal jaws; (d) seal jaw pressure control using a closed-loop pressure system comprising a pressure regulator valve in fluid communication with a pressurized air source without load cells; (e) at least one seal jaw clip configured to releasably slidably mount a seal jaw to a heater block, (f) an upper heater block release mechanism configured to releasably mount a heater block assembly to a reaction frame allow fast operator replacement of heaters and temperature transducers without tools, and (g) an integrated film guide and film cooling system.

2. An automated testing system according to claim 1, wherein the system includes a plurality of the components (a)-(g).

3. An automated testing system according to claim 1, wherein the system includes all of the components (a)-(g).

4. An automated testing system according to claim 1, wherein the system includes the side-insertion peel clamps, and wherein the side-insertion peel clamps are configured as peel clamp modules that are releasably attached to a frame of the system to allow for ease of service.

5. A system according to claim 1, wherein the system includes the side-insertion peel clamps, and wherein the side-insertion peel clamps comprise a rigid non-pivoting body with a defined fixed geometry having one closed side portion, the peel clamps having a cantilevered forward leg and a rearward body portion defining a cavity therebetween for holding the film specimen, with one side portion of the leg being spaced apart from the rearward body portion to define a side entry gap space.

6. An automated packaging-film testing system comprising an integrated film guide and film cooling system comprising at least one substantially laterally extending bar with apertures in fluid communication with a fluid source, the at least one bar configured to hold a portion of a film specimen at a forward location while another proximate portion is pulled rearward into a testing position and to direct fluid through the apertures to cool heated film.

7. An automated testing system according to claim 6, wherein the at least one bar comprises a pair of spaced apart parallel bars, an upper bar and a lower bar, wherein the upper bar and the lower bar are configured to direct pressurized fluid toward a specimen.

8. An automated testing system according to claim 6, wherein the pair of bars extends across a plurality of testing stations, each configured to hold a respective specimen, and wherein the fluid source comprises ambient air.

9. An automated testing system comprising:
a motion assembly comprising a single drive system attached to one end portion of a laterally extending arm: and
a plurality of side-by-side testing stations, each station comprising a lower seal jaw attached to the arm, the lower seal jaw configured to heat and press a respective film specimen, wherein, in operation, the arm moves the plurality of lower seal jaws substantially in concert to thereby allow for fast extraction of film specimens from the seal jaws.

10. An automated testing system according to claim 9, wherein the single drive system comprises a motor attached to a linear rod that is attached to the end portion of the arm.

11. An automated testing system according to claim 9, wherein the drive system is configured to move the arm at a maximum speed of at least about 600 mm/sec.

12. An automated testing system according to claim 9, further comprising a plurality of peel clamps attached to a frame of the system to cooperate with the motion assembly, wherein pairs of vertically spaced apart peel clamps cooperate to hold a respective film specimen during testing, the peel clamps having a rigid non-pivoting body with a defined fixed geometry having one closed side portion, the peel clamps having a cantilevered forward leg and a rearward body portion defining a cavity therebetween for holding the film specimen, wherein one side portion of the leg is spaced apart from the rearward body portion to define a side entry gap space.

13. An automated packaging-film testing system configured to perform at least one of a Hot Tack Test, Heat Seal Test, and an Aged Seal Test, the system comprising:
a plurality of testing stations, each station configured to test a respective film specimen; and
a plurality of side-insertion peel clamps, one for each respective station, the side-insertion peel clamp comprising a resilient fluid-expandable member that cooperates with a substantially rigid side insertion finger to releasably clamp a film specimen.

14. An automated testing system according to claim 13, wherein the peel clamps have a rigid non-pivoting body with a defined fixed geometry having one closed side portion, the peel clamps having a cantilevered forward leg and a rearward body portion defining a cavity therebetween for holding the film specimen, wherein one side portion of the leg is spaced apart from the rearward body portion to define a side entry gap space.

15. A testing system according to claim 13, wherein each of the side insertion clamps are configured as replaceable self-contained module units that releasably matably attach to the system configured to allow access for replacement and/or service from a front of the system.

16. An automated system according to claim 15, wherein the peel clamp modules are releasably attachable to a frame of the system using a single attachment member.

17. An automated packaging-film testing system configured to perform at least one of a Hot Tack Test, Heat Seal Test, and an Aged Seal Test, the system comprising at least one film specimen positioning clip mounted on a front of the system, the clip configured to allow an operator to slide a film specimen in from an open end thereof to releasably hold film specimens in position.

18. An automated system according to claim 17, wherein the clip comprises a curvilinear profile with one open end portion and one closed end portion, the closed end portion affixed to a mounting substrate.

19. An automated system according to claim 17, wherein the system comprises a plurality of testing stations, and wherein each testing station comprises upper and lower spaced apart clips substantially vertically aligned with each open-end portion oriented in the same direction.

20. An automated system according to claim 17, further comprising first and second side insertion clamps, the first side insertion clamp residing below and proximate to the upper clip and the second insertion clamp residing above and proximate the lower clip.

21. An automated system according to claim 17, further comprising a finger recess formed in a substrate holding the clip residing proximate the clip.

22. An automated packaging-film testing system configured to perform at least one of a Hot Tack Test, Heat Seal Test, and an Aged Seal Test, the system comprising:
at least one testing station comprising seal jaws configured to apply a controlled sealant pressure during specimen testing; and
a seal jaw pressure control system in communication with the seal jaws, the pressure control system comprising a closed-loop pressure system with a pressure regulator valve in fluid communication with a pressurized air source, an air seal cylinder with a piston in communication with a respective seal jaw at each testing station, whereby the control system is configured to reliably control sealant pressure exerted by the respective seal jaws using pressure without load cells.

23. An automated system according to claim 20, wherein sealant pressure P-jaw, is calculated using a mathematical relationship between a known regulated pressure P-reg, piston area A-cyl, and seal jaw surface area A-jaw.

24. An automated packaging-film testing system configured to perform at least one of a Hot Tack Test, Heat Seal Test, and an Aged Seal Test, the system comprising:
a mounting frame;
a plurality of side-by-side testing stations attached to the mounting frame, each station configured to hold a respective specimen; and
a plurality of upper heater block assemblies configured to apply pressure and heat to specimens at each station, the heater block assemblies comprising a temperature transducer, a heater block, and a heater block release mechanism at an upper portion thereof attached to the mounting frame, the release mechanism configured to allow an operator to rotate the heater block assembly to hand-release the respective heater block thereby providing fast operator replacement of heaters and temperature transducers without requiring tools.

25. An automated packaging-film testing system configured to perform at least one of a Hot Tack Test, Heat Seal Test, and an Aged Seal Test, the system comprising:
a heater block assembly with a body, the heater block assembly configured to apply heat and pressure to a film specimen during specimen testing;
a replaceable seal jaw configured to reside on an upper or lower mounting surface of the heater block; and
at least one clip configured to releasably and snugly hold the seal jaw on the heater block.

26. A system according to claim 25, wherein the at least one clip comprises two spaced apart clips that extend forwardly across the heater block body, one on each end portion of the heater block body, wherein the clips apply a downward or upward force against the seal jaw to hold the seal jaw in position.

27. A system according to claim 26, wherein the mounting surface of the heater block body and an underside of the seal jaw are configured to matably mount to each other.

28. A system according to claim 27, wherein the heater block body comprises a laterally extending key and the seal jaw comprises a laterally extending slot.

29. An automated method of testing film specimens, comprising:
slidably receiving a film specimen;
automatically gripping the film specimen in first and second spaced apart peel clamps;
automatically performing a peel test by moving a motion arm down at a specified test rate;
electronically collecting force data with the peel force transducers;
displaying test data upon completion of the peeling test; and
releasing the specimens.

31. A computer program product for performing automated film specimen tests, the computer program product comprising:
a computer readable storage medium having computer readable program code embodied in the medium, the computer-readable program code comprising:
computer readable program code configured to direct actuators to cause a peel clamp to grip a film specimen; and
computer readable program code configured to carry out at least one of a Hot Tack Test, Heat Seal Test, and Aged Seal Test.
